(19) United States
(12) Patent Application Publication
(10) Pub. No.: US 2014/0022766 A1
(43) Pub. Date: Jan. 23, 2014

(54) Electro Illuminating Wire Lighted Safety Vests

(71) Applicant: Rayma Charlene Wright, Las Vegas, NV (US)

(72) Inventor: Rayma Charlene Wright, Las Vegas, NV (US)

(21) Appl. No.: 13/915,646

(22) Filed: Jun. 12, 2013

Related U.S. Application Data
(60) Provisional application No. 61/661,253, filed on Jun. 18, 2012.

(51) Int. Cl. F21V 33/00

(52) U.S. Cl. CPC F21V 33/0076
USPC 362/108

(57) ABSTRACT

Safety vests and garments are for enhancing the visibility of a wearer in low-light, poor vision conditions. The safety garment has a first reflective layer, a second layer of reflective tape, physically attaching Electro Illuminating Wire under the inside edge of the reflect tape that maybe sewn or glued secures the Electro Illuminating Wire in place. Electro Illuminating Wire is then connected to a standard battery pack of old circuitry. The Electro Illumination Wire and glue are available on the market, Electro Illuminating Wire is old circuitry, prior art. Physically attaching the Electro Illuminating Wire to safety garments, creates a new environment, new area for a brighter and versatile safety garment. The Electro Illuminating Wire adds greater visibility to safety garments. Wearers have the option to turn on a bright solid light or bright blinking light, simply by pressing a button. This adding even greater visibility to wearers. Stopping injury or even death.

This application claims priority from Provisional Application No. 61/661,253 filed Jun. 18, 2012 entitled “El Wire lighted safety vests”.

Field of Search:

| | | |
|---|---|---|
| 5535106 | July 1996 | Tangen |
| 5567034 | October 1996 | Dietewich et al. |
| 5570945 | November 1996 | Chien et al. |
| 5607227 | March 1997 | Yasumoto et al. |
| 5632549 | May 1997 | Fang |
| 5690411 | November 1997 | Jackman |
| 5779348 | July 1998 | Interlicchio |
| 5984488 | November 1999 | Tung |
| 6059414 | May 2000 | Tsai |
| 6085698 | July 2000 | Klein |
| 6086213 | July 2000 | Holce |
| 6106130 | August 2000 | Harding |
| 6146006 | November 2000 | Cross |
| 6267481 | July 2001 | Miller et al. |
| 6481130 | November 2002 | Wu |
| 6517214 | February 2003 | Mitchell, Jr. et al. |
| 6619831 | September 2003 | Kanesaka |
| 6769138 | August 2004 | Golle et al. |
| 6834395 | December 2004 | Funtes |
| 2004/0062032 | April 2004 | Mass |

References Cited [Referenced By]
U.S. Patent documents

| | | |
|---|---|---|
| 1348698 | August 1920 | Coulson |
| 4328533 | May 1982 | Paredes |
| 4523258 | June 1985 | Morse et al. |
| 4630180 | December 1986 | Muraki et al. |
| 4709307 | November 1987 | Branom |
| 4941072 | July 1990 | Yasumoto et al. |
| 5032960 | July 1991 | Katoh |
| 5070436 | December 1991 | Alexander et al. |
| 5161872 | November 1987 | Sasaki et al. |
| 5249106 | September 1993 | Barnes et al. |
| 5295047 | March 1994 | Windross |
| 5424922 | June 1995 | Wise |
| 5535106 | July 1996 | Tangen |

### FIELD OF THE INVENTION

Embodiment of the invention relate generally to the field of safety vests and garments. More particularly, embodiments of the invention relate to a safety garment and safety vest for enhancing the visibility of the wearer in low-light, poor weather conditions.

### BACKGROUND OF THE INVENTION

There are many occupations, sports, and hobbies that require specific safety measures in order to prevent injury. Many of these measures rely on increasing the visibility of a user or location. Specifically, brightly colored vests worn to increase the visibility of a person are typically worn by many workers to enhance their safety. Police officers often wear safety vests when directing traffic or working an accident scene. These vests are often worn over their garments and are made in high-visibility colors such as neon orange, yellow, or green. To increase visibility, these vests often include reflective tape to reflect the light from car headlights when used at night. likewise, similar safety vests are worn by Department of Transportation personnel and many other persons whose occupations require them to work in close proximity to highways and other means of high vehicular traffic. Additionally, airport personnel use high-visibility safety vests when working on the ramp area around aircraft.

Another segment of society that often utilize high-visibility safety vests are people participating in sports such as hunting, fishing, cycling, snow skiing, and running. All of these sports rely on these vests to highlight the participant in order to protect them from being shot by other hunters or hit by vehicles whose drivers would not otherwise see them without a safety vest. Another benefit of using safety vests when participating in certain sports allow the wearer to be more closely tracked to prevent them or their companions from becoming lost. Hunter and fishermen often hunt and fish with others, but may become separated as they wander the woods or downstream from one another. By wearing brightly colored vests, the hunters or fishermen can better keep track of one another since the vests allow them to see each other from greater distances than would otherwise

Even through these high-visibility safety vests greatly improve the chance that a wearer of the vest will be seen by others, certain limitations still exist. First, a brightly colored vest may be adequate for certain applications when used in a well-lit environment, but the ability for a colored vest to distinguish a wearer from the surrounding environment greatly diminishes as the ambient light also diminishes. As mentioned above, reflective tape is sometimes used to increase the visibility of a vest. This tape works well as long as the light source, i.e. headlights, is directed to the tape, but diminishes as the light source moves away from the reflective tape. This attribute of the reflective tape creates a hazard for workers in certain situations. For example, a person working at a location such as an intersection, where a vehicle might turn towards them only when it is already close to the worker, might not be seen until it is too late since the headlights of the vehicle will not shine in the direction of the worker until the vehicle turns in that direction. Additionally, most safety vests described above will not aid sportsmen in keeping within sight of one another once ambient light diminishes to the point that the vest can no longer be seen. Reflective tape does not help in this situation as the person as the person wearing the vest may be too far away from a person with a light source such as a flashlight.

There are safety vests that have self-illumination features, such as vests made by POLYBRITE INTERNATIONAL of Naperville, Ill. These vests and others with illumination features only provide a user with a single safety feature, namely illumination, manufactured in a single configuration. A user may have the option of turning the illumination on and off, but is left with the particular configuration of reflective tape and the illumination sources established by the manufacturer. Additionally, light-emitting diodes (LEDs) are often left unprotected and susceptible to damage.

U.S. Pat. No. 4,891,896 issued on Jan. 9, 1990 to Boren and assigned to the Gulf Development Company is an example of many attempts to duplicate neon lighting. Like this attempt, most prior art neon simulations have resulted in structures difficult to fabricate and providing a little in the way of weight and handling benefits. The Boren patent exemplifies this by providing a plastic panel with essentially bas-relief lettering. The material comprising the lettering is transparent and coated with a translucent material. The surrounding material is opaque. When the panel is back lit the letting tends to glow with a neon-like intensity.

The more recent introduction of light weight and breakage resistant point light sources as exemplified by high intensity light emitting diodes (“LEDs”) have shown great promise to those interested in illumination devises that may simulate neon lighting and have stimulated much effort in that direction. However, the twin attributes of neon lighting, uniformity and brightness, have proven to be difficult obstacles to hurdle as such attempts to simulate neon lighting have largely been stymied by the tradeoffs between light distribution to promote the uniformity and brightness. Foe example, U.S. Pat. No. 4,976,057 issued Dec. 11, 1990 to Bianchi describes a device that includes a transparent or translucent hollow plastic tubing which is mounted in juxtaposition to a sheet of material having ligh transmitting areas that are co-extensive to the tubing. The tubing can be made into any shape including lettering. While the tubing may be lit by such arrangement is likely to result in a “glowing” tube having insufficient intensity to match that of neon lighting. The use of point light sources such as LEDs may provide intense light that rival or exceed neon lighting, but when arranged in arrays lack the uniformity needed and unfortunately provide alternate high and low intensity regions in the illuminated surfaces. attempts to smooth out the light has resulted in lighting that has unacceptably low intensity levels.

It is therefore a paramount object of the present invention to provide for an energy efficient, virtually unbreakable alternative to neon lighting.

A further importance object of the present invention is to provide for a light device that is safe to transport and economical to operate while providing all of the application virtues of neon lighting including uniformity and brightness.

Yet another object of the present invention is to provide for an alternative to neon lighting that is environmentally friendly, requiring no neon gas, and running on significantly less electricity that its neon equivalent.

Still another object of the present invention is to provide for a neon equivalent that is easy to install without complex high voltage electrical installations.

These and other objects of the present invention will become readily apparent and addressed through a reading of the discussion below and appended drawings.

### SUMMARY OF THE PRESENT INVENTION

The present invention utilizes a material having a wire-like characteristics that preferentially solid light entering a lateral surface of the wire (“light emitting surface”) is elongated along the length of the wire. A light source extends along and is positioned adjacent the light receiving surface and spaced from the light emitting surface a distance sufficient to create an enlongated light intensity pattern along the length of the wire. In a preferred arrangement, the light source is a wire-like solid light sufficient to permit the mapping of the light emitted so as to create elongated light intensity pattern along the light emitting surface and circumferentially about the surface so that the collective light intensity pattern is perceived as being uniform over substantially the entire surface when being viewed from a normal head-on and side perspectives.

### DESCRIPTION OF THE DRAWINGS

FIG. 1 This is the Front view of a Standard Well Known Safety Vest of the present invention.

FIG. 1 A-1 is an elevated perspective view of an electro illuminating wire attached, of the present invention.

FIG. 1 A-2 marks all the locations of the reflective tape of the present invention.

FIG. 1 A-3 is showing the stitching along the edge of the reflective tape on the front of the safety vest of the present invention.

FIG. 1 A-4 showing the location of Left aperture on the front of the safety vest of the present invention.

FIG. 1 A-5 showing the location of Right aperture on the front of the safety vest of the present invention.

FIG. 1 A-6 Showing the off/on button marked X on the reflective tape on the front of the safety vest of the present invention.

FIG. 1 B-1 showing inside pocket to hold battery pack, and left aperture of safety vest of the present invention.

FIG. 2 This is the Back view of the Standard Safety Vest of the present invention.

FIG. 2 C-1 is an elevated perspective back view of an electro illuminating wire attached, of the present invention.

FIG. 2 C-2 marks all the locations on the back of the reflective tape of the present invention.

FIG. 2 C-3 sewn stitching location to secure the electro illuminating wire under the edge of the reflective and the 1st layer of the safety vest, of the present invention.

FIG. 3 is an enlarged view of the cross section of the electro illuminating wire, of the present invention.

FIG. 3 D-1 sewn stitching to secure the electro illumination wire under the edge of the reflective tape and the 1st layer of the safety vest, of the present invention.

FIG. 3 D-2 showing the location of the reflective tape when attached, of the present invention.

FIG. 3 D-3 1″ clear plastic ends where they are placed and attached under the reflective tape and the 1st layer of the safety vest, of the present invention.

FIG. 3 D-4 showing the location of 1st layer of the safety vest, of the present invention.

FIG. 3 D-5 1″ plastic encasing the electro illuminating wire, of the present invention.

FIG. 3 D-6 showing the location of the electro illuminating wire after encased in plastic and attached to the safety vest, of the present invention.

FIG. 3 E-1 is enlarged view of the secured placement of the electro illuminating wire under the edge of the reflective tape, of the present invention.

### DETAILED DESCRIPTION

The present invention now will be described more fully hereinafter with reference to the accompanying drawings, in which illustrative embodiment of the invention are shown. This invention may, however, be embodied in many different forms and should not be construed as limited to the embodiment set forth herein; rather, these embodiments are provided so that this disclosure will be thorough and complete, and will fully convey the scope of the invention to those skilled in the art. Like numbers refer to like elements throughout.

For the people working or participating in sports or hobbies in close proximity to motor vehicles, aircraft, or other potential dangers, being visible could mean the difference between life or death. Aspects of the present invention provide improved safety vests & garments to be utilized by police, firemen, airport ramp workers, department of transportation personnel, construction workers, refuse collectors, military personnel, coast guards, ship operator and employees, hunters, runners, snow skiers, cyclists, and any other persons relying on enhanced visibility to ensure their safety. Safety vests & garments according to aspects of the present invention provide users with increased visibility in low light, poor weather conditions utilizing self illumination that does not rely on reflecting light from sources outside of the safety garments. The safety garments illumination sources are protected increasing the durability and life of the safety garments.

Embodiments of the present invention provide personnel not only increased safety, but also increased utility through flexible options and features. It should be understood by those skilled in the art that while the following description utilizes a safety garment to illustrate embodiments of the present invention, the invention is equally applicable to other garments such as hats, belts, pants, and rain gear.

The thin and flexile wire can be obtained from various sources such, as, for example, Flexible Circuit Technologies, Saint Paul, Minn. While the Electro Illuminating Wire is not part of the invention, it should be observed that the considerable sequence variety is permitted by the nature of the structure of the present invention. That is, the light weight, resistance to the rigors of packaging, handling, shipping, and installation, and the minimal heating aspects of the el wire permit essentially endless possibilities for lighting and color sequences. The el wire, may for example, be provided with various electrical component that permit flashing of the light sources in varied timed sequences and give the effect of moving. Various light source colors may be used with the present invention.

From the discussion above, it may be appreciated that the Electro Illuminating Wire of the present invention is rugged and resists breakage that normally would be expected for a neon or LED lighting counterparts in shipping and handling. The elector illuminating wire preferably solid state lighting such as el wire uses far less electrical energy and remains cool to the touch. This allows the el wire of the present invention to be used in places where the heat generated by neon and LED lighting precludes its use. Moreover, the light weight of the el wire facilitates mounting on support structures that could not support the relative heavy weight of the neon and Led lighting, and its required accessories including the high voltage infrastructure. Finally, the el wire is flexible in its use, allowing a tremendous variety of lighting techniques very difficult to obtain in neon and LED lighting without substantial expense. Other advantages and uses of the present invention will be clearly obvious to those skilled in the art upon a reading of the disclosure herein and are intended to be covered by the scope of the claims set fourth below.

I claim:

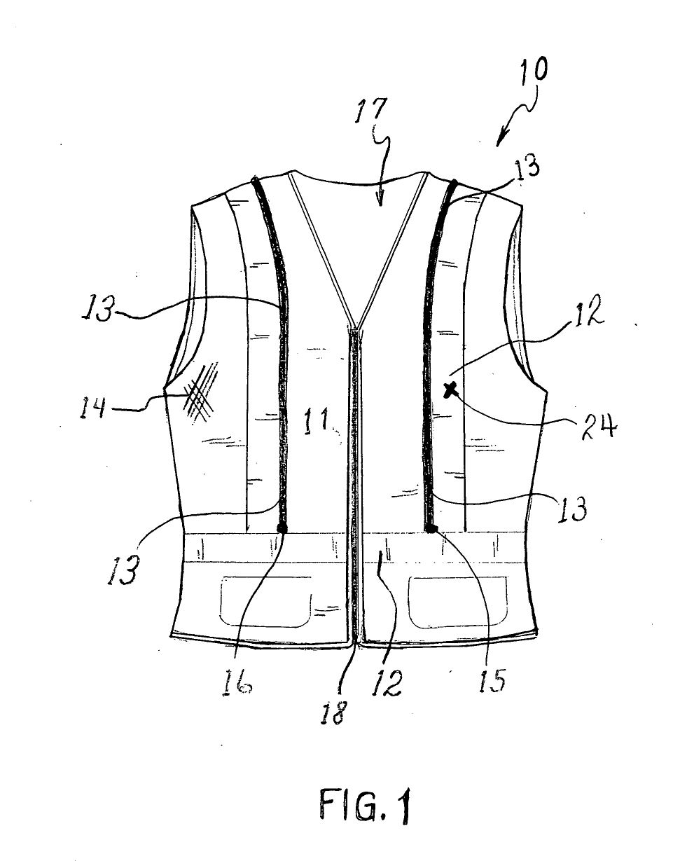

1. FIG. 1, 27,28. Physically combining a well known, old circuitry, Electro Illuminating Wire, (referenced as el wire) having a battery pack, and market available safety vests and garments (reference as safety vests). This has created a new environment and area from combining of the two. FIG. 5, 24,27,29 By physically attaching the el wire, by stitching or gluing with flexible adhesive that is market available. FIG. 6, 24,27,28,29,30. The el wire is attached under the inside edge of the reflective tape. Starting at the left front of the safety vests aperture, FIG. 4, 26,27,29. El wire is attached inside to a battery pack held securely by a pocket. FIG. 1, 29. Starting at the left front waist aperture, el wire is attached securely under the reflective tapes inside edge, 27,29 then runs up the left front of the safety vest over the left shoulder, down the left back to the waist, 27 across the waist to the right side, 27 up the right back shoulder, 27 down the right front ending at the right aperture, 29 and exiting their and attached securely inside waist area. 29. El wire is cool to touch, water resistant, and very flexible and uses little electricity. FIG. 9, Wearers have the ability to choose a bright solid light or a bright blinking light, by pressing a button 34 on the left front of the safety vest. This will enhance the ability to be seen in low-light. poor weather conditions, saving wearers from injury or even death.

2. The safety vests and garments(market available) 10, wherein the first layer is a reflective color of fabric or mesh, the second layer is reflective tape, 24,28,68.

3. The electro illuminating wire wherein is attached to a well known, standard battery pack, of old circuitry, prior art and market available. 32,33.

4. The safety vests, FIG. 6, 24,27,28,29,30, wherein the electro illuminating wire is permanently connected under the edge of the second layer, known as reflective tape 24. El illuminating wire is permanently connected to top edge of first layer 28, know as mesh or fabric 28. Having a second reflectance greater than the first reflectance;

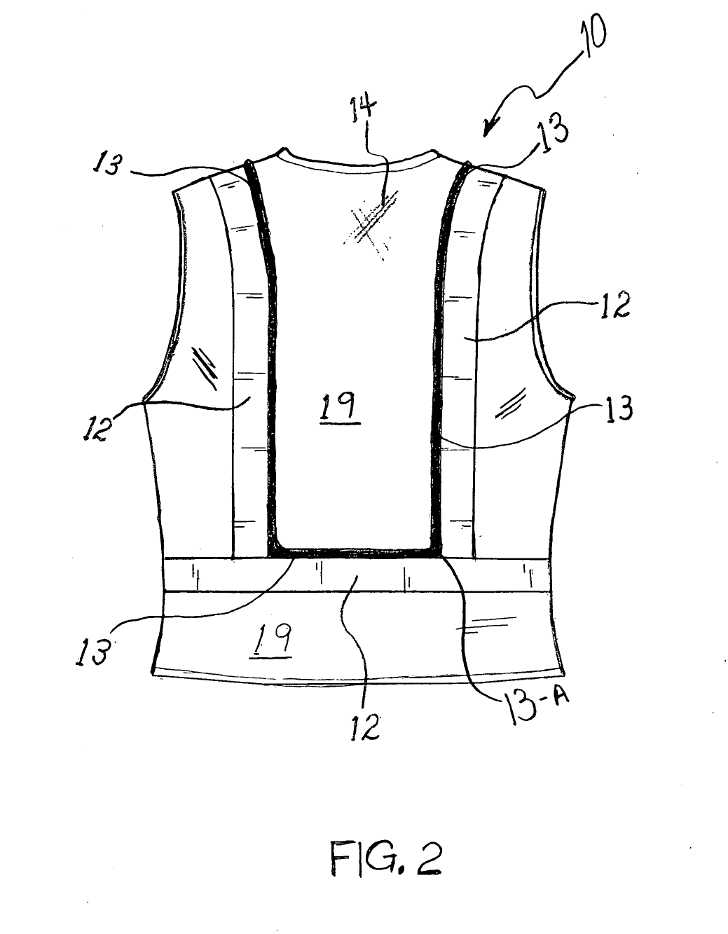

5. The safety vest, FIG. 1, 24,27,29, FIG. 2, 27 comprising; a first layer comprising of mesh or fabric with reflective color 28, connected to the second layer, the reflective tape 24, having a second reflectance greater than the first reflectance; chosen from the group comprising said layer and said second layer 24; and a predetermined length of electro illuminating wire 27 is secured under the inside edge of the reflective tape FIG. 5 27,39, electro illuminating wire is connected to a battery pack 32, thru a aperture 29, on the left front inside of the safety vest, 29.

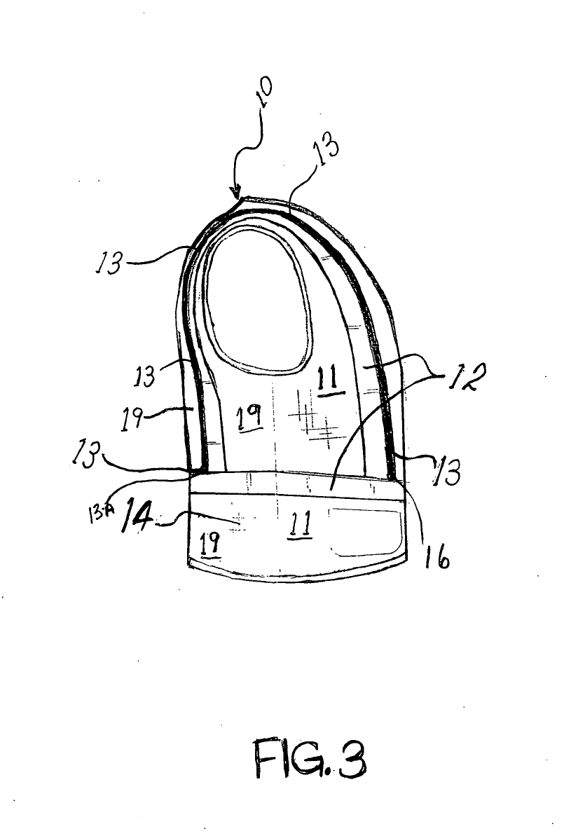

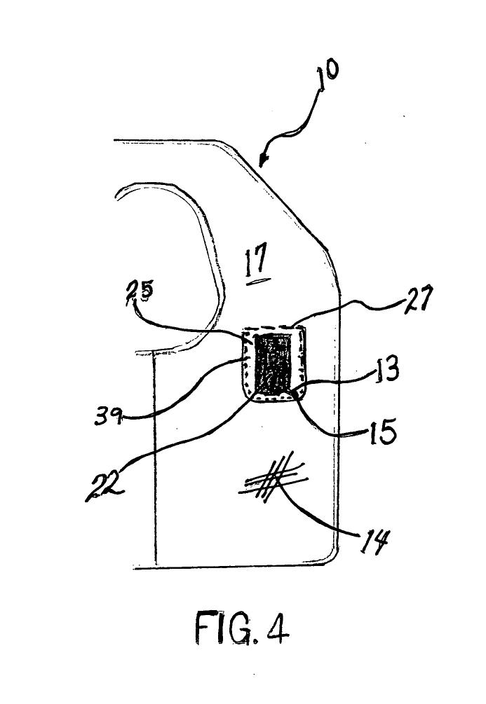

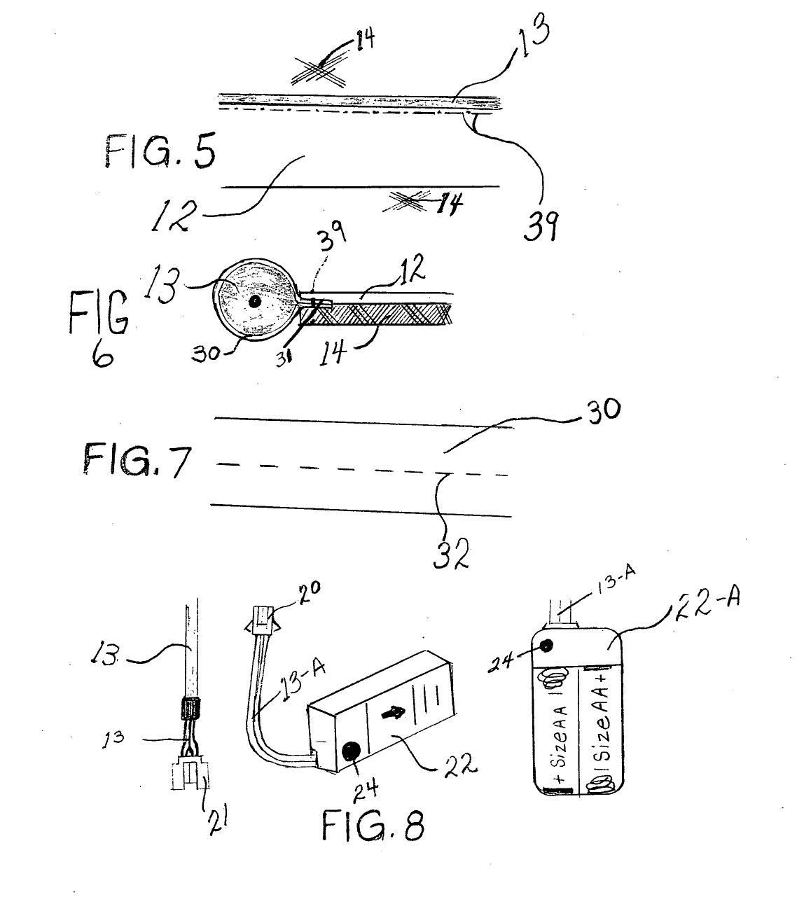

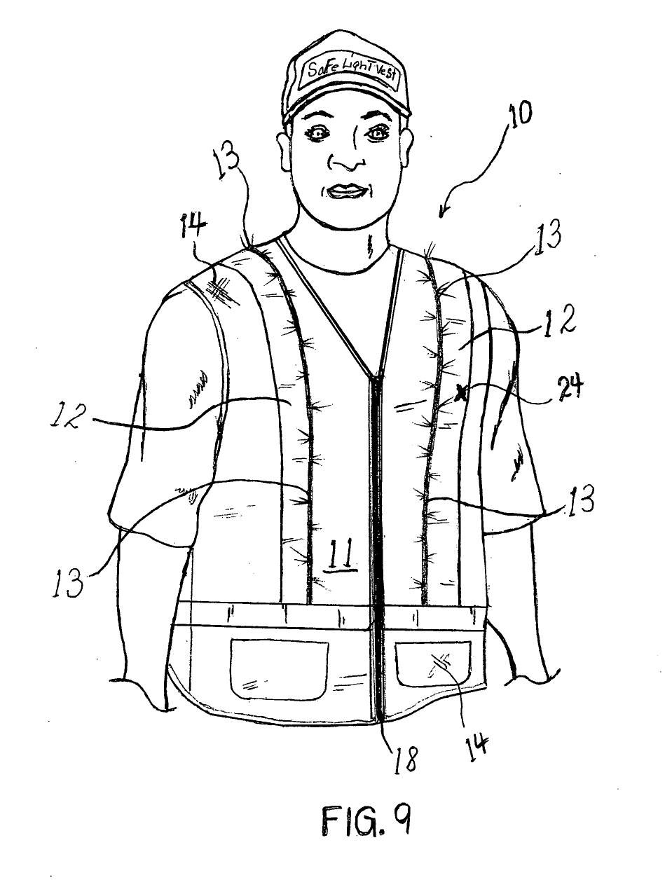

6. FIG. 3 The Safety vest of claim showing side view of the safety vest and attachment of electro illuminating wire 27.

7. The safety vest FIG. 4, 26 further comprising a pocket attached to the inside of the first layer, the pocket is sized for receiving and keeping the battery pack secure and in place. 32.

8. The safety vest of claim wherein the battery pack is located within left front insid of the safety vest, and attaches thru the aperture located on the front left side of the safety vest to the electro illuminating wire. FIG. 4, 29,27.

9. The safety of claim wherein the battery pack is a low-profile standard battery pack, well known and of old circuity. 32,35.

10. The safety vest of claim has a detachable battery pack, with a male 40 and female 41 connectors.

11. The safety vest of claim further comprising of sewn stitches or glued to keep electro illuminating wire securely in place. FIG. 5, 24,27,39.

12. The safety vest of claim, where physically attaching electro illuminating wire to the safety vest, creates a new environment and area 27, creating a highly-visible safety vest and safety and safety garments 10.

13. The safety vest of claim, the electro illuminating wire is light weight and is cool to touch, water resistant, with a removable battery pack, and uses small amounts of electricity, with ease a button located left front of safety vest 34 to turn on, off, for a solid light or blinking. FIG. 9. 32,34.
